(19) United States
(12) Patent Application Publication
(10) Pub. No.: US 2010/0068605 A1
(43) Pub. Date: Mar. 18, 2010

(54) REJUVENATION AND REUSE OF DEGRADED LITHIUM ION BATTERY CELLS

(75) Inventors: Stephen J. Harris, Bloomfield, MI (US); Merry Michelle Walker, Ann Arbor, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/545,299

(22) Filed: Aug. 21, 2009

Related U.S. Application Data
(60) Provisional application No. 61/096,932, filed on Sep. 15, 2008.

(51) Int. Cl. H01M 10/44; H01M 6/04

(52) U.S. Cl. 429/47; 429/188

(57) ABSTRACT

One embodiment includes a method for rejuvenating failed or degraded pouch-type lithium-ions batteries.

This application claims the benefit of U.S. Provisional Application No. 61/096,932, filed Sep. 15, 2008.

### TECHNICAL FIELD

The field to which the disclosure relates includes rejuvenation and reuse of degraded lithium ion batteries.

### BACKGROUND

Lithium-ion batteries are a type of recharageable battery in which a lithium ion moves between an negative electrode and a positive electrode. Lithium ion batteries are commonly used in consumer electronics. In addition to uses for consumer electronics, lithium-ion batteries are growing in popularity for defense, automotive, and aerospace applications due to their high energy density.

FIG. 1 illustrates a top plan view of a conventional lithium ion battery 10 that may be used in automotive applications having an electrode assembly 12 and a pouch 14, which may be formed with an interior region 16 for receiving the electrode assembly 12. The components of the electrode assembly 12 and pouch 14 are illustrative of the basic components and not intended to be depicted in proper orientation or scale.

The electrode assembly 12 may include a first electrode plate 20, a second electrode plate 30, and a separator 40 arranged between the first and second electrode plates 20 and 30 to prevent a short circuit between the first and second electrode plates 20 and 30 and allowing only lithium ions to pass through it. The electrode assembly 12 may be formed by winding the first electrode plate 20, the separator plate 40, and the second electrode plate 30 into a jelly roll type structure. Alternatively, as shown in FIG. 1, the first electrode plate 20, the separator 40, and the second electrode plate 30 may be sequentially laminated into a stack structure. Moreover, as shown in FIG. 1, the first electrode plate 20 is a negative electrode, while the second electrode plate 30 is a positive electrode, although the reverse arrangement is contemplated. A liquid electrolyte 45 is also introduced within the interior region 16 of the pouch 14 prior to the pouch 14 being sealed.

A positive tab 50 and a negative tab 52 electrically connected to the respective electrode plates 20, 30 of the electrode assembly 10 may be installed such that a predetermined length of them may be exposed outside the case pouch 14. Portions of the electrode tabs 50 and 52 that come in contact with the case pouch 14 may be wrapped with an insulating tape (not shown).

The positive electrode 20 may be formed by coating a strip shaped metal plate such as a positive collector with a positive active material. In one exemplary embodiment, the metal plate may be made of an aluminum film, while the positive active material may be formed from a lithium based oxide as a main component, a binder, and a conductive material. The positive electrode 20 may be electrically connected to a positive tab 50 and wrapped with insulating tape (not shown).

The negative electrode 30 may be formed by coating a strip shaped metal plate such as a negative collector with a negative active material. The metal plate may be made of a copper film while the negative active material may be formed from a carbon material as a main component, a binder, and a conductive material. The negative electrode 30 may be electrically connected to the negative tab 52 and wrapped with insulating tape (not shown).

The separator 40 may be made of a polyethylene film, a polypropylene film, or a combination thereof. The separator 40 may be formed to be wider than the positive and negative plates 20 and 30 to prevent a short circuit between the positive and negative plates 20 and 30.

The liquid electrolyte 45 may include solid lithium salt electrolytes such as LIPF₆, LIBF₄, or LIClO₄, and organic solvents such as carbonate. The liquid electrolyte 45 conducts lithium ions, which acts as a carrier between the negative electrode 30 and the positive electrode 20 when the battery 10 passes an electric current through an external circuit.

The pouch 14 may be formed from a wide variety of materials that are both flexible and heat sealable such that no oxygen or water vapor may enter. The pouch 14 may be a laminate material consisting of aluminum and plastic.

Both the positive electrode 20 and negative electrode 30 are materials into which and from which lithium can migrate. When a cell is discharging, the lithium is extracted from the negative electrode 20 and inserted into the positive electrode 30. When the cell is charging, the reverse process occurs: lithium is extracted from the positive electrode 30 and inserted into the negative electrode 20.

### SUMMARY OF EXEMPLARY EMBODIMENTS OF THE INVENTION

One exemplary embodiment includes a method for rejuvenating failed or degraded pouch-type lithium-ions batteries.

In one exemplary method, the pouch may be opened in a substantially water-vapor free and oxygen-free environment. To ensure a substantially water-vapor free and oxygen-free environment, an argon gas rich environment may be utilized. Next, solvent may be introduced to the opened pouch to dissolve a portion of the solid electrolyte interphase (SEI) layer that has low lithium ion conductivity. The solvent, dissolved SEI layer components and liquid electrolyte may then be removed from the pouch. Fresh liquid electrolyte is introduced to the pouch, and the pouch may then be resealed to complete the rejuvenation.

In another exemplary embodiment, the pouch may be opened in a substantially water-vapor free and oxygen-free environment and a substantial portion of the liquid electrolyte may be removed. To ensure a substantially water-vapor free and oxygen-free environment, an argon gas rich environment may be utilized. Next, a solvent may be introduced to the opened pouch to dissolve a portion of the SEI layer that has low lithium ion conductivity. The solvent, dissolved SEI layer components and any remaining liquid electrolyte may then be removed from the pouch. Fresh liquid electrolyte may then be introduced to the pouch, and the pouch may be resealed to complete the rejuvenation.

Other exemplary embodiments will become apparent from the detailed description provided hereinafter. It should be understood that the detailed description and specific examples, while disclosing exemplary embodiments, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a perspective view of a lithium ion battery in accordance with the prior art;

FIG. 2 illustrates a logic flow diagram for rejuvenating the lithium ion battery of FIG. 1,

FIGS. 3A and 3B are a front view and a side view of an apparatus for rejuvenating the lithium ion battery of FIG. 1 according to one exemplary method; and

FIG. 4 is a schematic representation of an apparatus for rejuvenating the lithium ion battery according to another exemplary method.

### DETAILED DESCRIPTION OF EXEMPLARY EMBODIMENTS

The following description of the embodiment(s) is merely exemplary (illustrative) in nature and is in no way intended to limit the invention, its application, or uses. Thus, the following description describes a lift gate panel as one exemplary example of a formed metal sheet that utilizes the novel principles described herein.

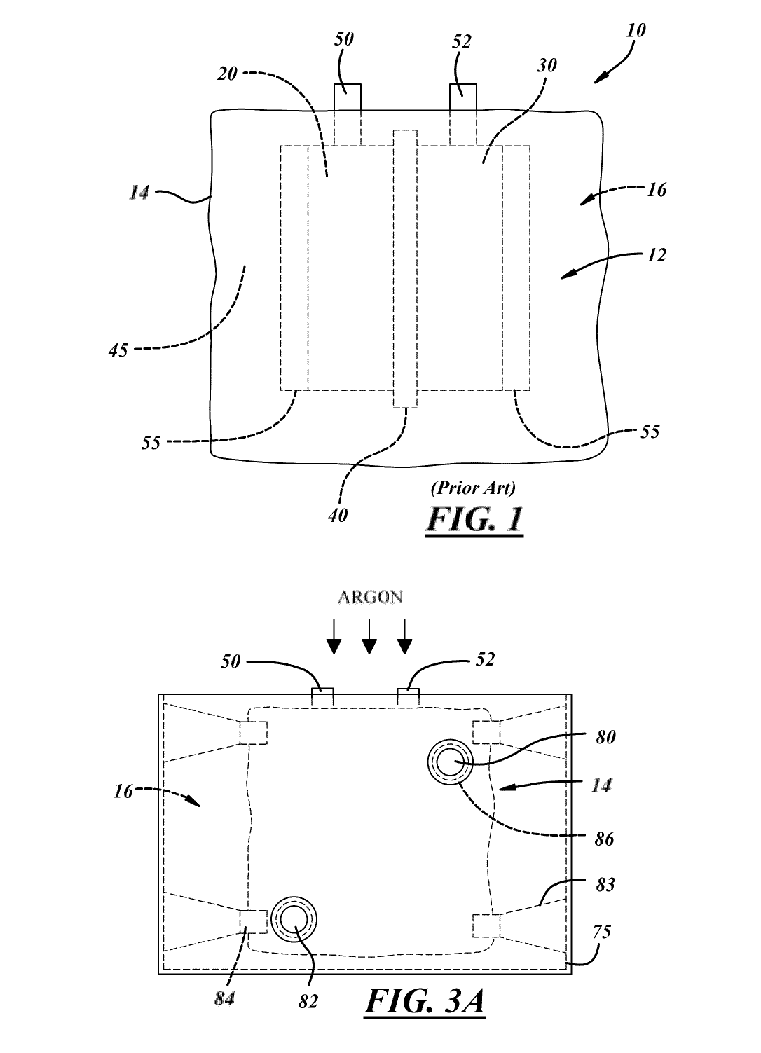

The exemplary embodiments herein may disclose methods for rejuvenating a pouch type lithium ion battery, including the conventional lithium ion battery 10 described above in FIG. 1. As such, the methods herein will be described in conjunction to rejuvenating the conventional pouch-type lithium ion battery 10 shown in FIG. 1, but are not limited to the configuration disclosed in FIG. 1 but may be available for rejuvenating all pouch type lithium ion batteries. In addition, the methods described herein may also be utilized in rejuvenating other prismatic lithium ion battery cells to which pouch-type lithium ion battery cells are a subset.

During operation of the lithium ion battery 10 such as described in FIG. 1, a portion of the liquid electrolyte 45 may be decomposed to form lithium salts and other polymeric materials that make up a solid electrolyte interphase (SEI) layer 55, including the solid electrolyte salts, on the surface of the negative electrode 30 and subsequently on the positive electrode 20 during initial operations. The SEI layer 55, and more specifically precipitated lithium flouride (LiF) from the liquid electrolyte 45 on the SEI layer 55 that may occur during continued operation of the battery 10, is thought to affect the conducting of lithium ions, and may contribute to resistive electrical paths to parts of the positive or negative electrode 20, 30 (i.e. which may lead to capacity loss as a result of aging). In addition, the thickening, cracking, dissolution, or chemical degradation of the SEI layer 55 otherwise may also lead to capacity loss of the battery.

The power and capacity loss associated with these changes in the SEI layer 55, as well as the decomposition of the liquid electrolyte 45, are thought to be at least partially reversible, and thus a low power and capacity battery 10 may be able to recover at least a portion of its power and capacity for further use by reversing the effects of the change on the SEI layer 55 and/or by the decomposition of the liquid electrolyte 45.

In general, the methods disclosed herein assume that the lithium ion battery 10 similar to that shown in FIG. 1 has lost power and capacity for one of two separate or related reasons. First, the SEI layer 55, on either the first electrode 20 or second electrode 30, is believed to be contributing to or otherwise causing the power and capacity loss for the battery 10. The SEI layer 55, and more specifically precipitated lithium flouride (LiF) from the liquid electrolyte 45 on the SEI layer 55 that may occur during continued operation of the battery 10, is thought to affect conduction of lithium ions, and may contribute to resistive electrical paths to parts of the negative electrode 30 (i.e. which may lead to capacity loss as a result of aging). Second, that the decomposition of a portion of the liquid electrolyte 45 may be contributing to or otherwise causing the power and capacity loss for the battery 10. Third, a combination of both root causes may be causing the power and capacity loss in the battery 10. Thus, the exemplary methods described herein may rejuvenate the battery 10 by attacking, or reversing the effects, of these root causes.

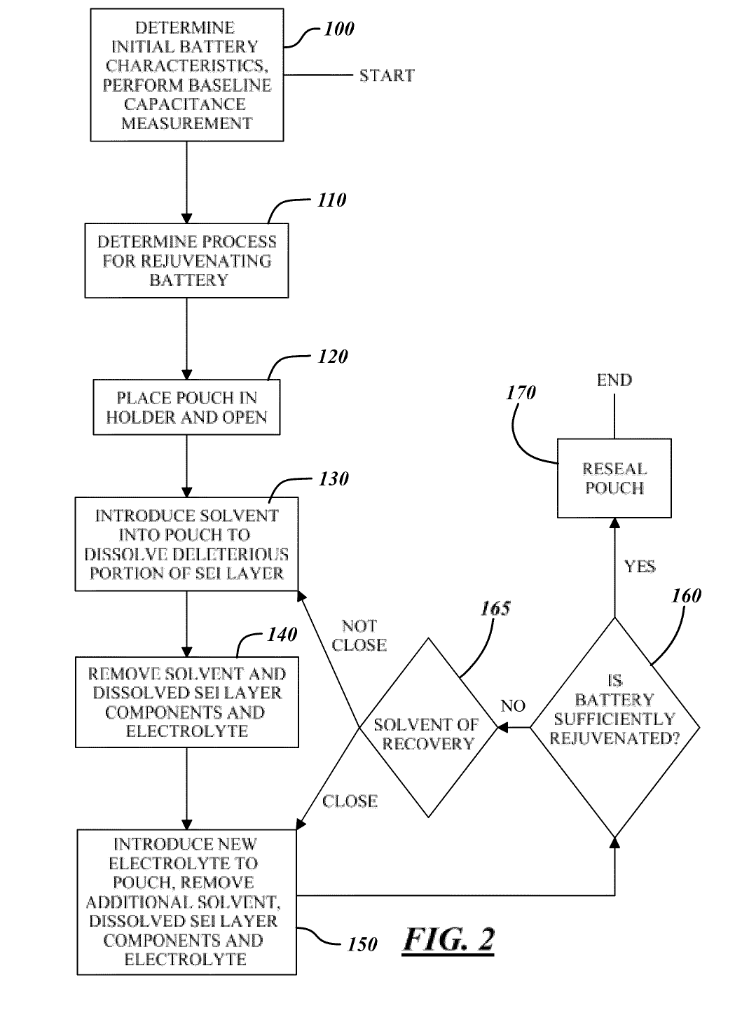

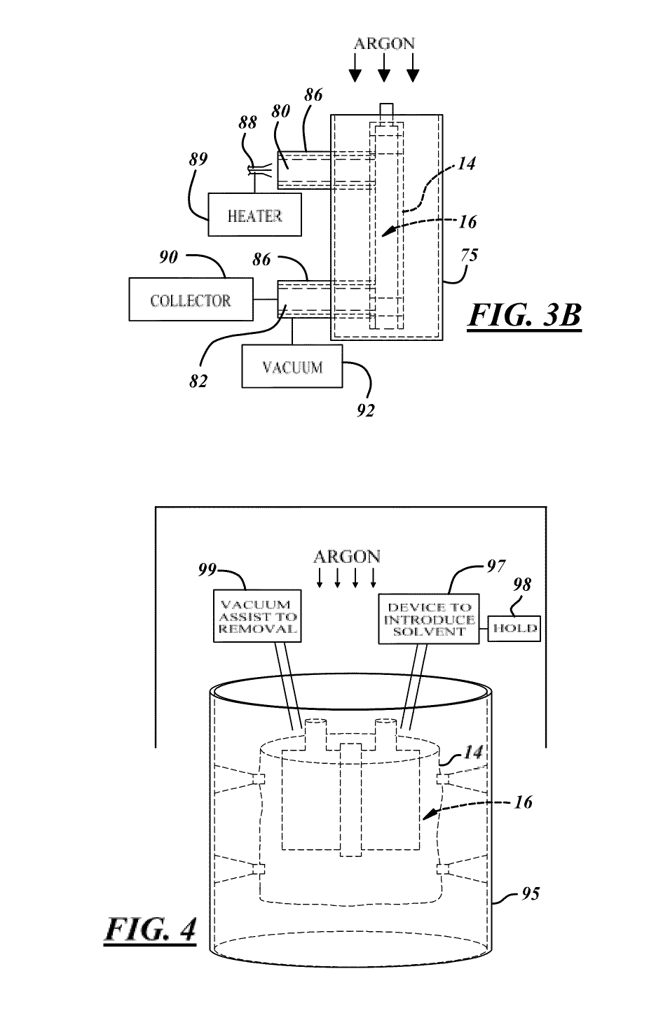

Referring first to FIG. 2, a logic flow diagram for one embodiment of a method for rejuvenating the battery 10 under two separate exemplary methods is described with in more detail below respect to FIGS. 3 and 4.

As illustrated by block 100 of FIG. 2, the power and capacity of the lithium ion battery 10 may be measured by conventional means to establish a baseline. In addition, the compositions of the liquid electrolyte 45, the positive electrode 20, and the negative electrode 30 for the lithium ion battery 10 may be gleaned from reviewing the product literature associated with manufacture of the battery 10 to be rejuvenated.

As illustrated by block 110, a determination may be made as to the process for rejuvenating the battery 10 that are based on the measured power and capacity from block 100. The parameters may include the types and amount of solvent to be introduced to remove the SEI layer 55, the amount of time the chosen solvent needs to fully dissolve the SEI layer 55, and the necessity for heating the solvent in aiding in the SEI layer 55 material removal. The parameters may also include a review of what the typical initial power and capacity is for the battery 10 to be rejuvenated prior to its initial use.

Next, as illustrated by block 120, the pouch 14 may be placed into a holder and the interior region 16 of the pouch 14 may be opened or made otherwise accessible. This may be accomplished one of two exemplary ways, as will be described below with respect to FIGS. 3 and 4.

As illustrated by block 130, a solvent may be introduced to the interior region 16 of the pouch 14 for a sufficient period of time to substantially remove a portion of the SEI layer 55 containing the deleterious components such as lithium fluoride (LiF). This solvent may be heated to an elevated temperature sufficient to enhance removal of this deleterious portion of the SEI layer 55 without otherwise harming the components of the battery 10.

In the exemplary embodiments herein, the solvent may be heated to an elevated temperature sufficient to enhance the ability of the solvent to remove the portion of the SEI layer without otherwise damaging the electrodes 20, 30. In the exemplary embodiments described below, carbonate solvents may be introduced at around 100 degrees Celsius for a period of about 30 minutes. Non-limiting examples of carbonate solvents that may be utilized include ethylene carbonate, diethyl carbonate, ethyl carbonate, methyl carbonate, propylene carbonate, dimethyl carbonate, and mixtures thereof. One of ordinary skill in the art will recognize that solvents other than carbonate solvents may be used to dissolve the deleterious portion of the SEI layer 55, so long as these solvents do not otherwise harm the components of the battery 10 contained within the pouch 14. These other solvents may be used alone, or in combination, with the above-described carbonate solvents.

As illustrated by block 140, the solvent and dissolved portion of the SEI layer 55, as well as the original liquid electrolyte 45, may then be removed from the interior region 16 of the pouch 14. This removal can occur simultaneously as with the introduction of the solvent in block 130 due to positive pressure displacement within the pouch 14, or alternatively by other physical means associated with the method described below with respect to FIG. 4. The removed solvent, dissolved portion of the SEI layer 55 and liquid electrolyte 45 may be preferably captured in a suitable container for subsequent disposal, recycling or resale.

Next, as illustrated by block 150, fresh liquid electrolyte 45 may be introduced within the pouch 14 to replace and/or replenish the original liquid electrolyte 45. Fresh liquid electrolyte 45, as defined herein, may be liquid electrolyte similar in composition to the liquid electrolyte 45 introduced within the interior region 16 when the battery 10 was originally manufactured. Alternatively, fresh liquid electrolyte 45 may be of differing composition than what was originally introduced. The introduction of the fresh liquid electrolyte 45 may force any remaining solvent, dissolved portion of the SEI layer 55 or original liquid electrolyte 45 out from the interior region 16 of the pouch 14 through positive pressure.

Next, as illustrated by block 160, the battery 10 may be tested to determine whether the battery 10 is rejuvenated to a satisfactory level. This can occur in at least two distinctive ways.

In one exemplary method, the power and capacity of the rejuvenated battery 10 may be tested and compared to the baseline and to the listed initial power and capacity as determined in block 100. An increase in power and capacity may be an indication that the battery 10 is sufficiently rejuvenated.

Alternatively, in another exemplary embodiment, the composition of the material exiting from the interior region 16 of the pouch 14 may be tested chemically to determine its composition through conventional chemical analysis methods such as capillary electrophoresis. This chemical testing may occur continuously or at random intervals. When the composition of the material exiting the pouch 14 shows a substantial decrease in the amount of LiF or other deleterious material associated with the dissolved SEI layer 55, the battery 10 may be considered sufficiently rejuvenated.

Of course, in another exemplary embodiment, both power and capacity measurement of the battery 10 and chemical analysis of the material exiting from the interior region 16 of the pouch 14 may be performed to confirm whether or not the battery 10 may be sufficiently rejuvenated. If the battery 10 is deemed to be sufficiently rejuvenated, the process proceeds to block 170, otherwise the process proceeds to block 165.

As illustrated by block 165, a determination may be made as to whether the process should revert back to block 130 or 150. The determination may be made depending upon the extent of power and capacity recovery or the composition as determined by the power and capacity measurement in block 160 of the removed material. When the battery 10 has close to the desired power and capacity or wherein the chemical composition of the material exiting the battery 10 may be deemed close to ideal, revert to block 150, otherwise revert to block 130.

Finally, as illustrated by block 170, the pouch 14 may be resealed and the battery 10 is available for use.

In an alternative exemplary arrangement, blocks 160 and 170 may be reversed in order such that the battery 10 may be tested for rejuvenation after the pouch 14 has been resealed. In this exemplary embodiment, the testing method may be most likely limited to a power and capacity measurement. If the battery 10 is not satisfactorily rejuvenated, the pouch 14 may be reopened, wherein the process reverts to blocks 130 or 150 based upon the level of power and capacity recovery.

FIGS. 3 and 4 illustrate two distinct exemplary methods that may be used to rejuvenate a lithium ion battery 10 such as in FIG. 1 substantially in accordance with the exemplary logic described in FIG. 2.

Referring first to FIGS. 3A and 3B, one exemplary method for rejuvenating the battery 10 may be disclosed. In this method, the pouch 14 may be placed into a holder 75 for support. One or more clamps 84 may be used to secure the pouch 14 in a desired position.

Next, an inlet hole 80 and an outlet hole 82 may be punched into the pouch 14 to expose the interior region 16. Argon gas may be introduced in proximity to the holes 80, 82 to provide a positive pressure gradient to prevent leakage of materials out of the interior region 16 of the pouch 14 and through the holes 80, 82 and to substantially prevent any water vapor or oxygen from entering the pouch 14.

An injector device 88 such as a syringe may be sealingly coupled to the inlet hole 80, while a collector device 90 may be sealingly coupled to the outlet hole 82. A vacuum 92 may also be coupled in close proximity to the outlet hole 82 and collector device. A rubber seal 83, or o-ring 83, may be introduced at each hole 80, 82 to assist the optional vacuum 92.

Next, solvent (not shown) may be introduced from the injector device 88 within the interior region 16 of the pouch 14. The solvent may function to dissolve the deleterious portion of the SEI layer 55, especially under forced flow. The solvent may be heated prior to entering the interior region 16 using a heating device 89 that is coupled to or forms a portion of the injector device 88 to facilitate the dissolving of the deleterious portion of the SEI layer 55. The solvent may remain in the interior region 16 of the pouch 14 for a sufficient period of time to substantially dissolve the deleterious portion of the SEI layer 55.

As solvent is introduced to the interior region 16 through the injector device 88 and inlet hole 80, a portion of the liquid electrolyte 45 and dissolved portion of SEI layer 55 material and solvent (collectively, extractant 91) may simultaneously exit the outlet hole 82 due to positive pressure displacement and be collected in the collector device 90. A vacuum 92 may aid in removing the extractant 91.

After a period of time sufficient to ensure a substantial dissolution of the deleterious portion of the SEI layer 55, fresh liquid electrolyte 45 may be introduced to the interior region 16 of the pouch 14 through the injector device 88. This fresh liquid electrolyte 45 will displace additional extractant 91 by positive pressure displacement.

The introduction of fresh electrolyte 45 may continue for a predetermined amount of time sufficient to ensure that the vast majority of the solvent, dissolved deleterious portion of the SEI layer 55, original liquid electrolyte 45, and decomposed liquid electrolyte may be removed to the collector device 90. To ensure this, a sample of the extractant 91 exiting the exit hole 82 may periodically be analyzed for chemical content.

In one exemplary embodiment, the extractant 91 may be tested using capillary electrophoresis to ensure that the levels of solvent, dissolved deleterious components of the SEI layer 55 material, and decomposed liquid electrolyte in the extractant 91 are below a predetermined threshold level. Alternatively, the battery 10 may be tested for power and capacity level, wherein the liquid electrolyte 45 introduction may be stopped when the power and capacity reaches a predetermined threshold power and capacity, thus indicating that the lithium ion battery 10 has been sufficiently rejuvenated.

When the rejuvenation is complete, the injector device 88 and collector device 90 may be uncoupled from the inlet hole 80 and outlet hole 82, respectively. The holes 80, 82 may then be resealed through the use of patches (not shown) or heat sealing.

Another alternative exemplary method for rejuvenating the battery may be shown in FIG. 4. In this method, the pouch 14 may be placed into a holder 75 for support. One or more clamps 84 may be used to secure the pouch 14 in a desired position.

Next, the pouch 14 may be opened, preferably from the top as shown in FIG. 4, to expose the interior region 16. The exposure of the interior region 16 may be done under an argon rich environment of at least one atmosphere to ensure that the electrodes 20, 30 and electrolyte 45 may not be exposed to moisture.

Next, the original liquid electrolyte 45, including any decomposed electrolyte, may be extracted using an extraction device 99. In one exemplary embodiment, the extraction device 99 is vacuum assisted.

Next, solvent may be introduced to the interior region 16 through an introduction device 97 to wash the remaining components. The solvent, in one exemplary embodiment, may be a carbonate solvent as described above. The solvent may dissolve the deleterious portion of the SEI layer 55 material due to positive pressure flow. The solvent may remain in the interior region for a predetermined amount of time sufficient to ensure the substantial dissolution of the deleterious portion of the SEI layer 55. As in FIG. 3 above, the solvent may be heated prior to introduction using a heater device 98. The solvent, dissolved SEI layer 55 material, and any remaining original liquid electrolyte and decomposed electrolyte (collectively extractant 93) may be removed through the extraction device 99, and fresh solvent introduced from the introduction device 97 in one stage or in multiple stages.

The introduction of fresh solvent may continue for a predetermined amount of time sufficient to ensure that the vast majority of the deleterious portion of the SEI layer 55 has been dissolved. To ensure this, a sample of the extractant 93 entering the extraction device 99 may periodically be analyzed for chemical content using capillary electrophoresis or a similar technique as described above.

After a period of time sufficient to ensure a substantial dissolution of the deleterious portion of the SEI layer 55, followed by complete removal of all extractant 93, fresh liquid electrolyte 45 may be introduced to the interior region 16 of the pouch 14 through the introduction device 97.

Finally, the battery 10 may be tested for power and capacity level, wherein the washing process may be stopped when the power and capacity reaches a predetermined threshold power and capacity, thus indicating that the lithium ion battery 10 has been rejuvenated. This can occur prior to resealing the pouch 14, or after resealing the pouch 14. The rejuvenated battery 10 may then be available for subsequent use.

The lithium ion battery rejuvenation techniques described herein may provide a substantial cost savings, wherein the basic material costs for originally forming the lithium ion batteries 10 is very expensive. It is envisioned that lithium ion batteries for use in vehicles, in one exemplary usage, may be rejuvenated and reused in an on-site facility while the vehicle owner waits. In another exemplary usage, the lithium ion battery may be removed from the vehicle and replaced with a new or rejuvenated lithium ion battery, while the removed lithium ion battery may be restored for subsequent use, thus saving vehicle owners and manufactures substantial costs normally associated with replacement and/or warranties. Moreover, the rejuvenation techniques of the exemplary embodiments may be utilized on other prismatic lithium ion batteries, including other pouch type lithium ion batteries of differing configurations, and fall within the scope of the exemplary embodiments described herein.

The above description of embodiments of the invention is merely exemplary in nature and, thus, variations thereof are not to be regarded as a departure from the spirit and scope of the invention.

What is claimed is:

1. A method for rejuvenating a pouch type lithium ion battery, the battery including an electrode assembly substantially contained within a pouch, comprising:
opening the pouch;
introducing a solvent within the opened pouch to substantially dissolve a deleterious portion of a solid electrolyte interphase layer formed on a portion of the electrode assembly, said solid electrolyte interphase layer including said deleterious portion formed by the decomposition of a portion of a liquid electrolyte in the pouch;
removing a substantial portion of said solvent, said dissolved deleterious portion of said solid electrolyte interphase layer, said decomposed liquid electrolyte, and said liquid electrolyte from the opened pouch;
introducing a quantity of fresh liquid electrolyte to the opened pouch; and
resealing the pouch.

2. The method of claim 1, wherein opening the pouch comprises:
introducing an inlet hole in the pouch;
coupling an injection device to said inlet hole;
introducing an outlet hole in the pouch; and
coupling a collector device to said outlet hole.

3. The method of claim 2, wherein introducing a solvent within the opened pouch comprises:
introducing a quantity of solvent within an interior region of the pouch through said injector device.

4. The method of claim 2, wherein introducing a solvent within the opened pouch comprises:
coupling a heater device to said injector device;
heating a quantity of solvent within said heater device;
introducing said quantity of heated solvent to said injector device; and
introducing said quantity of heated solvent within an interior region of the pouch through said injector device.

5. The method of claim 2, wherein removing a substantial portion of said solvent, said deleterious portion of said dissolved solid electrolyte interphase layer, said decomposed liquid electrolyte, and said liquid electrolyte from the opened pouch comprises:
removing a substantial portion of said solvent, said deleterious portion of said dissolved solid electrolyte interphase layer, said decomposed liquid electrolyte, and said liquid electrolyte from the opened pouch through said collector device.

6. The method of claim 5 further comprising:
coupling a vacuum to said collector device to aid in removing said substantial portion of said solvent, said deleterious portion of said dissolved solid electrolyte interphase layer, said decomposed liquid electrolyte, and said liquid electrolyte from the opened pouch.

7. The method of claim 1, wherein said solvent comprises a carbonate solvent.

8. The method of claim 7, wherein said carbonate solvent comprises at least one of ethylene carbonate, diethyl carbonate, ethyl carbonate, methyl carbonate, propylene carbonate, dimethyl carbonate, or mixtures thereof.

9. The method of claim 1, wherein the introduction of said quantity of fresh liquid electrolyte to the opened pouch results in the removal of a substantial remaining portion of said solvent, said deleterious portion of said dissolved solid electrolyte interphase layer, said decomposed liquid electrolyte, and said liquid electrolyte.

10. The method of claim 9 further comprising:
determining a power and capacity of the pouch type lithium ion battery after the introduction of said quantity of fresh liquid electrolyte.

11. The method of claim 10, wherein said power and capacity is determined prior to sealing the pouch.

12. The method of claim 10, wherein said power and capacity is determined after sealing the pouch.

13. The method of claim 9 further comprising:
chemically analyzing the composition of an extractant exiting the pouch into said collector device after the introduction of said quantity of fresh liquid electrolyte to the opened pouch, wherein said extractant comprises said substantial remaining portion of said solvent, said deleterious portion of said dissolved solid electrolyte interphase layer, said decomposed liquid electrolyte, and said liquid electrolyte; and
predicting a level of power and capacity of the pouch type lithium ion battery as a function of the chemical composition of said extractant.

14. The method of claim 13, wherein said extractant further comprises a portion of said fresh liquid electrolyte.

15. A rejuvenated lithium ion battery formed according to the method of claim 1.

16. A method for rejuvenating a pouch type lithium ion battery, the battery including an electrode assembly substantially contained within a pouch, comprising:
opening the pouch;
removing a substantial portion of a liquid electrolyte from the opened pouch;
introducing a solvent within the opened pouch to substantially dissolve a deleterious portion of a solid electrolyte interphase layer formed on a portion of the electrode assembly, said solid electrolyte interphase layer including said deleterious portion formed by the decomposition of a liquid electrolyte in the pouch;
removing a substantial portion of said solvent, said deleterious portion of said dissolved solid electrolyte interphase layer, said decomposed liquid electrolyte, and said remaining liquid electrolyte from the opened pouch;
introducing a quantity of fresh liquid electrolyte to the opened pouch; and
resealing the pouch.

17. The method of claim 16, wherein opening the pouch comprises:
placing the lithium ion battery into an argon rich environment of at least one atmosphere; and
opening a top portion of the pouch.

18. The method of claim 17, wherein removing a substantial portion of liquid electrolyte from the opened pouch comprises:
providing a vacuum assisted removal device; and
removing a substantial portion of said liquid electrolyte from the opened pouch using said vacuum assisted removal device.

19. The method of claim 18, wherein introducing a solvent within the opened pouch comprises:
providing an introduction device;
introducing a quantity of solvent from said introduction device within the opened pouch to substantially dissolve a deleterious portion of said solid electrolyte interphase layer formed on a portion of the electrode assembly, said solid electrolyte interphase layer including said deleterious portion is formed by the decomposition of a liquid electrolyte in the pouch.

20. The method of claim 19, wherein introducing a solvent within the opened pouch comprises:
coupling a heater device to said introduction device;
heating a quantity of solvent within said heater device;
introducing said quantity of heated solvent to said introduction device; and
introducing said quantity of heated solvent within an interior region of the pouch through said introduction device.
